(19) United States
(12) Patent Application Publication
(10) Pub. No.: US 2020/0057448 A1
(43) Pub. Date: Feb. 20, 2020

(54) Vehicle guidance and positioning system at low speed by means of optical systems

(71) Applicant: AUTODRIVE SOLUTIONS S.L., Madrid (ES)

(72) Inventor: Alejandro Badolato Martín, Madrid (ES)

(21) Appl. No.: 16/461,381

(22) PCT Filed: Dec. 21, 2016
(86) PCT No.: PCT/IB2016/057873

§ 371 Date: May 16, 2019

(51) Int. Cl. G05D 1/02; G01C 21/34; B60R 11/04

(52) U.S. Cl. CPC G05D 1/0231; G05D 2201/0213; B60R 11/04; G01C 21/34

(57) ABSTRACT

The recommended invention refers to low speed vehicle guidance and positioning system by means of optical systems in surroundings where the lighting conditions are controlled and where a video camera attached to a vehicle that moves along a certain route aims at some part of the infrastructure (preferably the ground) and in the infrastructure there is coded information throughout the route on the vehicle's position with respect to a system of coordinates by means of shapes that are detected by the camera.

The relative movement of the reader with respect to the coded surface allows interrogating other areas of the surface and in this way the sensor is capable of decoding a message recorded throughout the route that the imaging sensor follows.

### CROSS-REFERENCE TO RELATED APPLICATIONS

Not Applicable

### STATEMENT REGARDING FEDERALLY SPONSORED RESEARCH OR DEVELOPMENT

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT INCORPORATION-BY-REFERENCE OF MATERIAL SUBMITTED ON A COMPACT DISC

Not Applicable

### BACKGROUND OF THE INVENTION TECHNICAL FIELD

### Field of the Invention

The field of the invention is that of the high-technology industry of positioning and control of moving objects that can be applied preferably in land transport devices such as AGV (Automated Ground Vehicles) or cranes.

### Description of Related Art

There is some background information on devices that perform similar information-reading functions.

Among them, the inventor is also the inventor of the international patent PCT/ES2015/070378 where a lane-guide installed at ground level of the highway is described as a means of coding, although optionally it can be hidden under a layer of asphalt treated with a layer of hydrophobic material of preferred dimensions of 1.5 cm in width by 5 cm of depth and where in its interior cavities are mechanized, with the preferred shape of the cavities being dihedrals since the planes of the dihedrals increase the reflected signal, thereby facilitating their detection.

The inventor knows the existence of the U.S. Pat. No. 2,996,137 (YAOHAN CHU) published on 15 Aug. 1961, where an information coding method is defined in an infrastructure in which it is also possible to use a detection method such as radar to acquire information.

The manner of incorporating the information on the infrastructure consists of the use of reflecting strips.

Therefore, it is a very different method, not only in the reading but also specifically in the coding of the infrastructure.

The inventor does not know of any previous patent that incorporates the devices that the current invention presents, or the advantages that this device entails.

### BRIEF SUMMARY OF THE INVENTION

The recommended invention refers to low speed vehicle guidance and positioning system by means of optical systems in surroundings where the lighting conditions are controlled.

A video camera attached to a vehicle that moves on a determined route is aimed at some part of the infrastructure (preferably the ground).

In the infrastructure, information is coded throughout the route on the position of the vehicle with respect to a system of coordinates by means of shapes that are detected by the camera.

An example of coding could be spots of paint that follow a coding system similar to the Braille reading system for the blind, barcodes or BIDI codes.

By means of digital treatment of the obtained image, the vehicle is capable of determining the position of the pattern or benchmark with respect to the camera and also read the coded information in it, which, in turn, provides information on the position of the benchmark with respect to an absolute coordinate system.

This information can be codified in two different wat:

i) In certain discreet points along the route, such as, for example, a set of BIDI codes deployed along a line that marks the route, or else ii) by means of continual information that while it serves to mark the route of the vehicle it contains a recorded message such as, for example, a Braille system where the projecting parts are substituted by geometric painted shapes.

In the second case, the relative movement of the reader with respect to the coded route allows it to decode the message with information on the position and associate that position with the position of the last geometric figure that ends the message.

### BRIEF DESCRIPTION OF THE DRAWINGS

Not Applicable

### DETAILED DESCRIPTION OF THE INVENTION

The recommended invention refers to a low speed vehicle guidance and positioning system by means of optical systems in surroundings where the lighting conditions are controlled.

A video camera attached to a vehicle that moves on a certain route points to some part of the infrastructure (preferably the ground).

In the infrastructure, information is coded throughout the route on the position of the vehicle with respect to a system of coordinates by means of shapes that are detected by the camera.

An example of coding could be drops of paint that follow a coding system similar to the Braille reading system for the blind, barcodes or BIDI codes.

By means of digital treatment of the obtained image, the vehicle is capable of determining the position of the pattern or landmark with respect to the camera and also read the coded information in it that, in turn, provides information on the position of the landmark with respect to an absolute coordinate system.

This information can be codified in two different forms: i) In certain discreet points along the route, such as, for example, a set of BIDI codes deployed along a line that marks the route or else ii) by means of continual information that while it serves to mark the route of the vehicle it contains a recorded message such as, for example, a Braille system where the projecting parts are substituted by geometric painted shapes.

In the second case, the relative movement of the reader with respect to the coded route allows it to decode the message with information on the position and associate this position with the position of the last geometric figure that ends the message.

### Description of the Preferred Embodiment

The low speed vehicle guidance and positioning system by means of optical systems that read the information on the position that is coded in the infrastructure consists of two elements:

A coding system on the infrastructure throughout its route by means of a set of geometrical shapes detectable by an imaging system.
An imaging device attached to the moving object that is aimed at the infrastructure and where the imaging device has the following elements:
a) A digital imaging system that allows identifying the geometric shapes and reading the coded information
b) A digital imaging system that allows estimating the position of the coded information with respect to the position of the camera.

The information is coded in the transversal axis of the route by several methods, with one of them consisting of the presence of two geometric shapes separated from each other by 10 cm and a third geometric figure located between them and with respect to the left figure in the driving direction of the route, as follows:
a) at a distance of 2 cm to associate the transversal axis to a logic level 0.
b) at a distance of 4 cm to associate the transversal axis to a logic level 1.
c) at a distance of 6 cm to associate the transversal axis to a logic level start bit of the word.
d) at a distance of 8 cm to associate the transversal axis to a logic level end bit of the word.

The information of the position is also coded in determined points of a line painted along the route and an image processing system that identifies the line and allows the moving object to follow it.

Within the preferred realization, the marks of the infrastructure are distinguished in that they present spots of paint on the surface throughout the route.

The spots of paint have a surface area of 1 square metre. The information is coded, having two spots of paint with a separation of 10 cm on an axis perpendicular to the route of the infrastructure.

The location of a third spot of paint between both determines the logic level of the transversal axis as described below:

1 spot separated 2 cm from the left spot in the vehicle's driving direction determines a logic level 1.
1 spot separated 4 cm from the left spot in the vehicle's driving direction determines a logic level 0.
1 spot separated 6 cm from the left spot in the vehicle's driving direction determines a logic level start bit of the word.
1 spot separated 8 cm from the left spot in the vehicle's driving direction determines a logic level end bit of the word.

The information is coded forming words that begin with a start bit, then 64 bits of data are codified into 1 or 0, and finally they have a stop bit. The separation between each of the transversal axes where 3 spots are coded is 2 cm.

This coded surface is read by means of a video camera that is attached to the underside of the vehicle. It has a field of vision of approximately 50×50 cm2. In addition, the camera can be attached to the vehicle on a motorized mobile transversal axis that allows it to move from one wheel to the other in order to facilitate the reading.

The vehicle's movement along the route allows exploring other parts of the surface and in this way the sensor is capable of decoding a message recorded on the situation and positioning.

It must be understood that the described forms of realization are only the preferred ones. That is, several characteristics can be omitted, modified or substituted by equivalents without deviating with respect to the scope of this invention, which is defined in the attached claims.

1. A low speed vehicle guidance and positioning system by means of optical systems that read the information on the position that is coded in the infrastructure and characterized in that the system consists of two elements:
a coding system on the infrastructure throughout its route by means of a set of geometric shapes detectable by an imaging system
an imaging device attached to the moving object that is aimed at the infrastructure.

2. The system according to claim 1 and characterized in that the imaging device has the following elements:
a digital image processing system that allows identifying the geometric shapes and reading the coded information
a digital image processing system that allows estimating the position of the coded information with respect to the position of the camera.

3. The system according to claim 1, characterized in that the infrastructure presents geometric shapes placed on transversal axes in the route.

4. The system according to claim 3, characterized in that the information is coded in the transversal axis by means of the presence of two geometric figures separated from each other by 10 cm and a third geometric figure located between the two, with respect to the left figure in the driving direction of the route, as follows:
at a distance of 2 cm in order to associate the transversal axis to a logic level 0
at a distance of 4 cm in order to associate the transversal axis to a logic level 1
at a distance of 6 cm in order to associate the transversal axis to a logic level start bit of the word
at a distance of 8 cm in order to associate the transversal axis to a logic level end bit of the word.

5. The system according to claim 1, characterized in that the information regarding position is coded on certain points of a line painted throughout the route and an image processing system identifies the line and allows the moving object to follow it.

6. The system according to claim 1, characterized in that the coded surface is read by means of a video camera that is attached to the underside of the vehicle and which has a field of vision of approximately 50×50 cm2 and in that the camera is attached to the vehicle on a motorized moveable transversal axis which allows movement between the two ends of the axis.
